(19) United States
(12) Patent Application Publication
(10) Pub. No.: US 2024/0412519 A1
(43) Pub. Date: Dec. 12, 2024

(54) TRAILER MONITORING SYSTEM

(71) Applicant: Gentex Corporation, Zeeland, MI (US)

(72) Inventor: Eric P. Bigoness, Ada, MI (US)

(73) Assignee: Gentex Corporation, Zeeland, MI (US)

(21) Appl. No.: 18/734,381

(22) Filed: Jun. 5, 2024

Related U.S. Application Data
(60) Provisional application No. 63/506,599, filed on Jun. 7, 2023.

(51) Int. Cl. G06V 20/52; G06T 7/521; G06T 7/70

(52) U.S. Cl. CPC G06V 20/52; G06T 7/521; G06T 7/70; G06V 2201/07

(57) ABSTRACT

A system includes an illumination source associated with a vehicle. The illumination source is configured to emit a structured light pattern onto a portion of at least one of a trailer towed by the vehicle and, if present, a load hauled by the trailer. A camera is associated with the vehicle and configured to capture the structured light pattern and generate one or more images of a scene. A controller is communicatively connected to the camera and configured to receive the one or more images from the camera, and create one or more depth map of the scene based, at least in part, on the one or more images. The controller is further configured to determine at least one of a position and an orientation of at least one of the trailer and the load, and detect the presence of a potentially hazardous condition related to towing the trailer.

### CROSS-REFERENCE TO RELATED APPLICATION

This application claims priority to and the benefit under 35 U.S.C. § 119(e) of U.S. Provisional Application No. 63/506,599, filed on Jun. 7, 2023, entitled “TRAILER MONITORING SYSTEM,” the disclosure of which is hereby incorporated herein by reference in its entirety.

### FIELD OF THE DISCLOSURE

The present disclosure relates, in general, to trailer monitoring systems and, more particularly, to camera-based trailer monitoring systems.

### BACKGROUND OF THE DISCLOSURE

Towing a trailer is fraught with difficulty. For example, trailers may be flat tires, have excessive sway, and are easy to bump into obstacles. Further, many of these issues are amplified by a driver's reduced ability to notice many of these issues due to reduced visibility and/or substantially independent movement of the trailer. Accordingly, there is a need for a reduction of the problems related to towing a trailer.

### SUMMARY OF THE DISCLOSURE

The present disclosure is directed to various aspects of a trailer monitoring system. This trailer monitoring system may use structured light machine vision in order to substantially reduce or eliminate problems associated with towing a trailer.

According to one aspect of the present disclosure, a system is disclosed. The system may comprise an illumination source, a camera, and/or a controller. The illumination source may be associated with a vehicle. Further, the illumination source configured to emit a structured light pattern onto a portion of at least one of: a trailer towed by the vehicle and, if present, a load hauled by the trailer. The camera may be associated with the vehicle. Further, the camera may be configured to capture the structured light pattern and generate one or more images of a scene that includes the structured light pattern illuminated onto the portion. The controller may be communicatively connected to the camera and configured to: receive the one or more images from the camera; create one or more depth map of the scene based, at least in part, on the one or more images; determine at least one of a position and an orientation of at least one of the trailer and the load; and detect the presence of a potentially hazardous condition related to towing the trailer.

In some embodiments, the structured light pattern may include a quasi-random arrangement of illumination elements. In some embodiments, the structured light pattern is emitted onto the portion of the trailer. In some embodiments, the structured light pattern is emitted onto the portion of the load.

In some embodiments, at least one of the position and the orientation of the trailer are determined. In some such embodiments, the detection and the presence of the potentially hazardous condition may be based, at least in part, on comparing the at least one of the position and the orientation of the trailer against a previously determined position or orientation, respectively. Further, the detection of the presence of the potentially hazardous condition may be based, at least in part, on the comparison indicating that the trailer underwent movement that was at least one of large, repeated, cyclical, or erratic. In some such embodiments, the detection of the presence of the potentially hazardous condition is based, at least in part, on comparing the at least one of the position and the orientation of the trailer against at least one of an expected position and orientation of the trailer. Further, the at least one of the expected position and orientation of the trailer may be based, at least in part, on steering of the vehicle.

In some embodiments, at least one of the presence, position, and the orientation of the load are determined. In some such embodiments, at least one of the position and the orientation of the load may be determined relative to the trailer. Further, the detection of the presence of the potentially hazardous condition may be based, at least in part, on comparing the at least one of the position and the orientation of the load relative to the trailer against previously determined positions and/or orientations of the load relative to the trailer. Furthermore, the detection of the presence of the potentially hazardous condition may be based, at least in part, on movement of the load relative to the trailer. Additionally or alternatively, the detection of the presence of the potentially hazardous condition may be based, at least in part, on the disappearance of the load from the one or more images.

In some embodiments, the system may further comprise a notification device. The notification device may be communicatively connected to the controller. Further, the notification device may be configured to provide at least one of a visual and audible alert based, at least in part, on the detection of the potentially hazardous condition. In some such embodiments, the notification may be provided to an occupant of the vehicle. In some such embodiments, the notification may be provided to an individual remotely located relative to the vehicle.

In some embodiments, the vehicle may be at least partially autonomously driven. In some such embodiments, the vehicle may be configured to pull over based, at least in part, on the detection of the presence of the potentially hazardous condition.

According to another aspect of the present disclosure, a system is disclosed. The system may comprise a camera, a controller, and/or a notification device. The camera may be associated with a vehicle. Further, the camera may be configured to capture light and generate one or more images of at least one of: a trailer towed by the vehicle and, if present, a load hauled by the trailer. The controller may be communicatively connected to the camera and configured to: receive the one or more images from the camera, perform an object identification analysis based, at least in part, on the one or more images, to identify the presence or absence of at least one of the trailer and the load, compare the object identification analysis results against previous object identification analysis results, and detect a potential theft of at least one of the trailer and the load based, at least in part, on the comparison. The notification device may be communicatively connected to the controller. Further, the notification device may be configured to provide at least one of a visual and audible alert based, at least in part, on the detection of the potential theft of at least one of the trailer and the load.

In some embodiments, the notification device is configured as at least one of a mobile phone or a rearview mirror assembly.

These and other aspects, objects, and features of the present disclosure will be understood and appreciated by those skilled in the art upon studying the following specification, claims, and appended drawings. It will also be understood that features of each embodiment disclosed herein may be used in conjunction with, or as a replacement for, features in other embodiments.

### BRIEF DESCRIPTION OF THE DRAWINGS

In the drawings:

FIG. 1 is a block diagram schematic of a trailer monitoring system, according to an aspect of the present disclosure;

FIG. 2 is an illustration of a scene monitored by a trailer monitoring system, according to an aspect of the present disclosure;

FIG. 3 is a top plane view of a trailer being pulled by a vehicle with a trailer monitoring system, according to an aspect of the present disclosure; and

FIG. 4 is a schematic view of a control system of a trailer monitoring system, according to an aspect of the present disclosure.

### DETAILED DESCRIPTION

The present illustrated embodiments reside primarily in combinations of method steps and apparatus components related to camera-based trailer monitoring systems. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

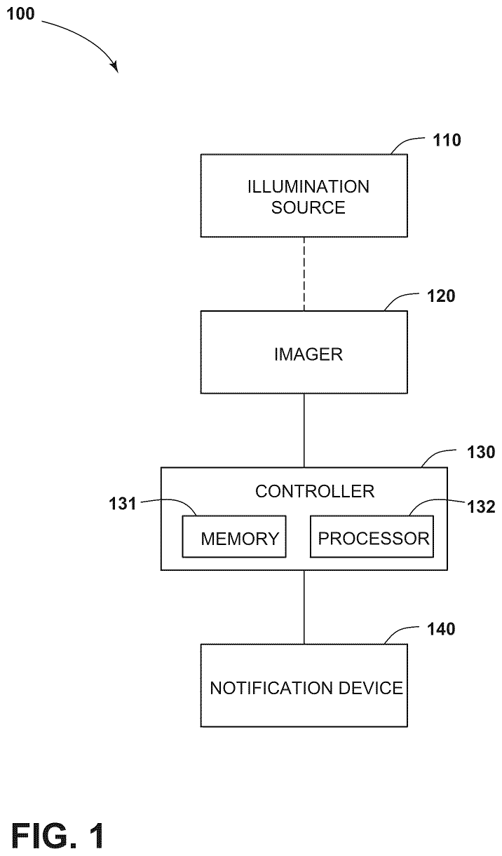

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1-3 illustrate various aspects of a trailer monitoring system 100. Trailer monitoring system 100 may comprise an illumination source 110, an imager 120, a controller 130 (e.g., control system 200), and/or a notification device 140. In some embodiments, any combination of the elements of trailer monitoring system 100 may be disposed within a common housing or two or more housings. Further, trailer monitoring system 100 may be associated with a vehicle 10. Additionally, vehicle 10 may be configured to tow a trailer 20. Trailer 20 may or may not be hauling a load 30. If present, the load 30 may be detected (e.g., by controller 130). As used herein, the illumination source 110 and imager 120 may be part of a vision system.

With reference now to FIGS. 1-4, Illumination source 110 is configured to emit a structured light pattern 111 onto at least part of a scene 40 rearward vehicle 10 and may operate under the principles of structure light. Accordingly, structured light pattern 111 may be substantially emitted across a portion of trailer 20, when in tow. Structured light pattern 111 may be formed by a plurality of illumination elements 112. Illumination elements 112 may be generated in any shape or pattern. For example, illumination elements 112 may be lines, grids, shapes, spots, dots and/or any combination thereof. In some embodiments, structured light pattern 111 may be a quasi-random arrangement or pattern of illumination elements 112. In some embodiments, the illumination may be at an eye-safe, low power level.

In some embodiments, illumination source 110 may comprise a light source and/or an optical element 114. The light source may be configured to emit light in the visible and/or non-visible regions of the electromagnetic spectrum, which may be used to create structured light pattern 111. In some embodiments, the emitted light may or may not be coherent. Additionally or alternatively, the emitted light may be collimated or semi-collimated. The light source, for example, may be a vertical cavity emitting laser (VCSEL) or a diode laser. The optical element 114 may be configured to receive the light emitted from the light source and split into structured light pattern 111 upon transmission. For example, the optical element 114 may be a diffractive or refractive optical element. Thus, in some embodiments, optical element 114 may include diffraction grating. In some embodiments, the optical element 114 may include a collimation element and a diffractive element. The collimation element and the diffractive element may be integrally or separately formed to transform the illumination from the illumination source 110 to the structure light pattern 111 and illumination elements 112. In some embodiments, the vision system may further include a flood light source 116 that projects a flood illumination towards the trailer 20 and load 30. The flood illumination may include light in the visible and/or non-visible regions of the electromagnetic spectrum, such that imager 120 may further be configured to capture the flood illumination in image data 122. In this manner, the image data can include 2D information of the trailer 20 and load 30 in low light conditions that may be generated on the notification device 140.

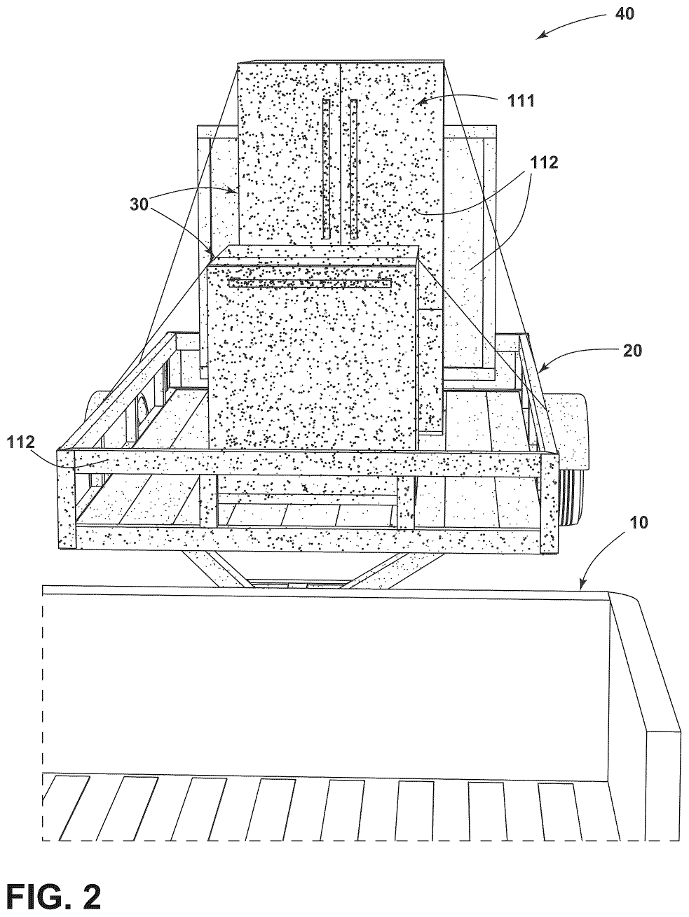

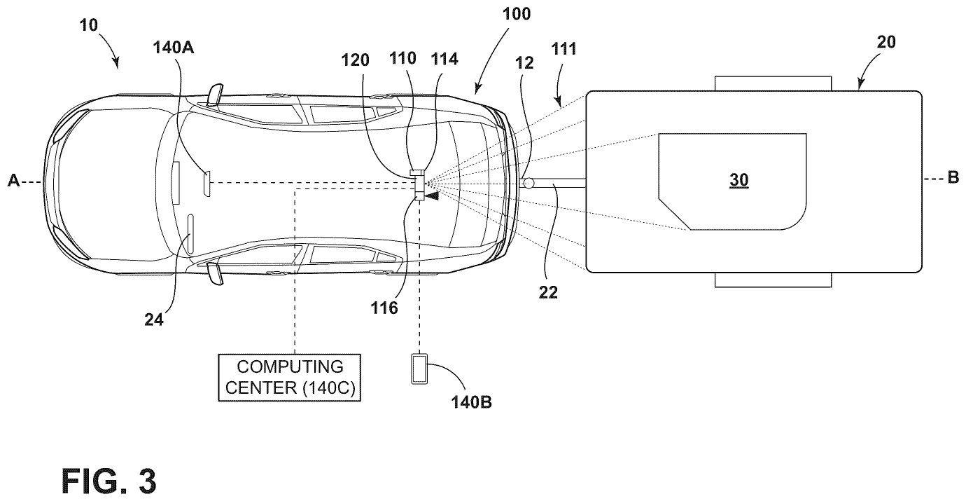

With reference to FIGS. 2 and 3, the imager 120 may be any device configured to capture light (e.g., the illumination elements 112) and generate one or more corresponding image data 122 (e.g., images, videos, and/or the like). Further, imager 120 may have a field of view including scene 40. Thus, the image data 122 may include the light of structured light pattern 111. For example, imager 120 may be a camera configured to capture light in the visible and/or non-visible regions of the electromagnetic spectrum. Accordingly, imager 120 may be a Semi-Conductor Charge-Coupled Device (CCD) or a pixel sensor of Complementary Metal-Oxide-Semi-Conductor (CMOS) technologies. The scene 40 may include the trailer 20 and load 30. For example, the scene 40 may include a bottom surface of the trailer 20 (e.g., an axle and wheels), side surfaces of the trailer 20 (e.g., wheels), and/or a top surface of the trailer 20 (e.g., the load 30).

Controller 130 (e.g., the control system 200) may be communicatively connected to imager 120 and/or illumination source 110. Accordingly, controller 130 may be configured to activate illumination source 110 between one and off states. Additionally, controller 130 may be configured to receive the image data 122 (e.g., one or more images) from imager 120. In some embodiments, controller 130 may be housed within a common housing along with illumination source 110 and/or imager 120. In other embodiments, controller 130 may be located elsewhere within vehicle 10. For example, controller 130 may be part of a central computer or management system of vehicle 10. In yet other embodiments, controller 130 may be remotely located as a server and/or cloud. In some embodiments, the vision system (e.g., imager 120 and/or illumination source 110) may be located in housing and the housing may be located along a top surface of the vehicle 10 (FIG. 3), a rear surface of the vehicle 10, a side surface of the vehicle, and/or combinations thereof. In some embodiments, the vision system may be coupled (e.g., attached) to the trailer 20. Further, controller 130 may comprise a memory 131 and a processor 132.

The detection of a hazardous condition may be based, in-part, on one or more of movement of the trailer 20 and load 30 over a period of time, a position of the trailer 20 and load 30, relative positioning between the trailer 20 and load 30, and relative positioning between the trailer 20 and the vehicle 10. As depicted in FIG. 3, the vehicle 10 may generally extend along a first axis A and the trailer may generally extend along a second axis B. The controller 130 (e.g., the control system 200) may therefore be configured to determine the relative positioning and changes in relative positioning between the first and second axis A, B. As depicted in FIG. 3, the vehicle 10 may include a hitch mount 12 (e.g., a ball mount) and the trailer 20 may include a hitch latch 22 (e.g., tow coupler) coupled to the hitch mount 12. Therefore, in addition or alternatively monitoring the vehicle 10 position (e.g., the first axis A) relative to the trailer 20 position (e.g., the second axis B), the vision system and controller 130 (e.g., the control system 200) may utilize the hitch mount 12 and the hitch latch 22 as references to the first and second axis A, B. The relative positions between the first and second axis A, B may generally be defined in a cross-car direction (e.g., along a flat plane) and/or an up-and-down direction relative to a driving surface (e.g., a road). As will be described in greater detail below, the relative positioning between the first and second axis A, B may be compared to inputs from a steering system 24 (e.g., a steering wheel).

Memory 131 may be a non-transitory computer-readable media (CRM). Accordingly, memory 131 may be a tangible device may be configured to store one or more instructions, such as one or more algorithms, to provide for the configuration and operation of controller 130. Examples of memory 131 include conventional hard disks, solid-state memories, random access memories (RAM), read-only memory (ROM), erasable programmable read-only memory (EPROM), electronically erasable programmable read-only memory (EEPROM), optical or magnetic disks, dynamic random-access memory (DRAM).

Processor 132 may be communicatively connected to memory 131. Further, processor 132 may be any device or electronic circuit configured and/or operable to process or execute one or more sets of electronic instructions, such as the algorithm. These instructions may be stored in memory 131. Examples of processor 132 may include a central processing unit (CPU), a microprocessor, and/or an application specific integrated circuit (ASIC).

In some embodiments, controller 130 may be configured to create one or more depth map of the scene 40 based, at least in part, on image data 122 (e.g., one or more of the one or more images) generated by imager 120. In some such embodiments, controller 130 may be configured to compare the one or more images against a calibration image (e.g., a 2D image captured via illumination from the flood light source 116 or ambient lighting), which illustrates structured light pattern 111 illuminating scene 40 under certain conditions. The calibration image may provide controller 130 as a reference of the pattern of the structured light. The depth data may be extracted from the image data 122 based on triangulation of one of more of the reflected illumination elements relative others and/or and known geometries between imager 120, the illumination source 110, and the distribution of the structured light pattern 111. For example, controller 130 generates the depth map in accordance with the teachings of U.S. Pat. No. 11,310,466, which is herein incorporated by reference. The depth map may also be referred to herein as a three-dimensional (“3D”) representation that is extrapolated via the controller 130 (e.g., the control system).

In some embodiments, controller 130 may perform an object identification analysis on one or more of the one or more images and/or depth maps. Accordingly, controller 130 may identify trailer 20. Additionally, controller 130 may determine a position and/or orientation of trailer 20 based, at least in part, on the one or more depth maps. Additionally or alternatively, controller 130 may identify at least part of a load 30 hauled by trailer 20. As such, the controller may determine a position and/or an orientation of load 30. Further, the position and/or orientation of load 30 may be determined relative to trailer 20.

It should be appreciated that the vision system may operate under one or more of a variety of principles for extrapolating the 3D representation. For example, the vision system may include two or more imagers 120 and operate under the principles of stereovision, the principles of Time-of-Flight, LiDAR, and/or other operating principles.

In some embodiments, the position and/or orientation of trailer 20 may be compared against an expected position and/or orientation of trailer 20. The expected position and/or orientation of trailer 20 may be determined by controller 130 based, at least in part, on steering of vehicle 10. Thus, controller 130 may identify when trailer 20 is not in an expected position and/or orientation. Such a condition may be indicative of a hazardous condition. Accordingly, controller 130 may detect the presence of a potentially hazardous condition with respect to trailer 20 by comparing the position and/or orientation of trailer 20 against an expected position and/or orientation of trailer 20.

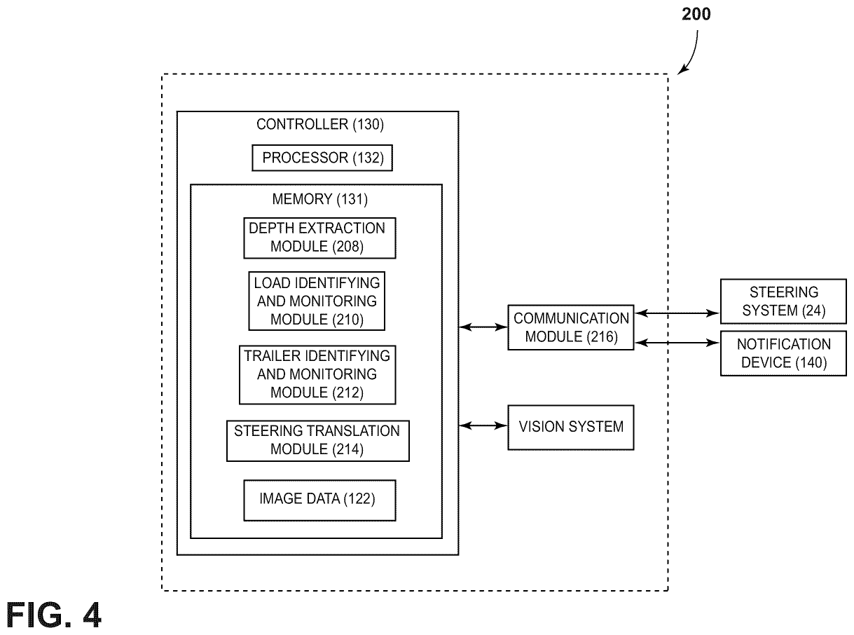

With reference now to FIG. 4, the control system 200 of the trailer monitoring system 100 may include the controller 130. The controller 130 may be located in a rearview mirror assembly 140A, a personal computing device 140B, other structures in the vehicle 10, and/or a central computing center 140C. For example, the computing center 140C may be physically or cloud-based and provide information to, for example, an entity managing a fleet of vehicles hauling trailers. In some embodiments, components of the control system 200 communicate with one another and are located in more than one location. The controller 130 may include the processor 132 and the memory 131. The processor 132 may include any suitable processor 132. Additionally, or alternatively, the controller 130 may include any suitable number of processors, in addition to or other than the processor 132. The memory 131 may comprise a single disk or a plurality of disks (e.g., hard drives) and includes a storage management module that manages one or more partitions within the memory 131. In some embodiments, memory 131 may include flash memory, semiconductor (solid state) memory, or the like. The memory 131 may include Random Access Memory (RAM), a Read-Only Memory (ROM), Electrically Erasable Programmable Read-Only Memory (EEPROM), or a combination thereof. The memory 131 may include instructions that, when executed by the processor 132, cause the processor 132 to, at least, perform the functions associated with the components of the trailer monitoring system 100. The vision system (e.g., the illumination source 110 and the imager 120) may, therefore, be controlled by the control system 200. The memory 131 may, therefore, include a series of captured image data 122. The memory 131 may further include modules (e.g., instructions) that include a depth extraction module 208, a load identifying and monitoring module 210, a trailer identifying and monitoring module 212, a steering translation module 214, and image data 122.

The depth extraction module 208 may include instructions for extrapolating the depth map or 3D representation of scene 40. More particularly, the instructions may include extrapolating the depth map or 3D representation under the principles of structured light, stereovision, Time-of-Flight, LiDAR, and/or other operating principles.

The load identifying and monitoring module 210 may include instructions for object detection and identification of the load 30. For example, the identifying and monitoring module 210 may include or otherwise access pre-saved models of various types and/or classifications of loads. In some embodiments, a user may identify the load 30 via a user interface (e.g., on the notification module 140). For example, the types and/or classifications may include extrapolating a size of the load 30 and what the load 30 is (e.g., boxes, wood, vehicles, etc.). The monitoring aspects of the instructions may include initially (e.g., when the vehicle 10 is started and/or starts to move) determining the size, type, and location of the load 30 and monitoring the load 30 for relative movements with respect to the trailer 20. For example, the load identifying and monitoring module 210 may generate a signal to the notification device 140 upon the hazardous condition that may include relative movement of the load 30 beyond a threshold. The threshold may include a distance between a starting position of the load 30 and a current position of the load 30, overall movement of the load 30 over a predetermined amount of time (e.g., about 5, 10, 15, 30, 60 seconds), changes in orientation of the load 30 (e.g., the load 30 being knocked over within the trailer 20, balance of the load 30 causing instability of the trailer 20, or changes in the presence of the load 30 (e.g., that the load 30 is no longer detected on the trailer 20). Further, in some embodiments, the load identifying and monitoring module 210 may monitor safety ties for the hazardous condition (e.g., that the safety ties are taught vs loosening) and generate a signal to the notification device 140 if the safety ties are loosening or become unattached from the trailer 20 or the load 30.

In some embodiments, the position and/or orientation of load 30 relative to trailer 20 may be compared against previously determined positions and/or orientations of load 30 relative to trailer 20. As such, controller 130 may identify movement of load 30 relative to trailer 20 and/or the sudden disappearance from view of load 30. Such a condition may be indicative of load 30 being improperly secured to trailer 20. Thus, controller 130 may identify an improperly secured load 30, which at the very least may present the risk of damage or loss to load 30 and at most present a physical danger to the driver of vehicle 10 and/or others on the road. Accordingly, controller 130 may detect the presence of a potentially hazardous condition with respect to trailer 20 and/or its load 30 by comparing the position and/or orientation of load 30 relative to trailer 20 against previously determined positions and/or orientations of load 30 relative to trailer 20.

The trailer identifying and monitoring module 212 may include instructions for object detection and identification of the trailer 20. For example, the identifying and monitoring module 210 may include or otherwise access pre-saved models of various types and/or classifications of trailers 20 (e.g., length, width, number of tires). In some embodiments, a user may identify characteristics of the trailer 20 via a user interface (e.g., on the notification module 140). The trailer identifying and monitoring module 212 may further include instructions to monitor the trailer 20 for hazardous conditions. For example, the hazardous condition may include an angle between the first axis A and the second axis B beyond a threshold maximum angle in the cross-car direction or in the up and down direction. The hazardous condition may further include monitoring relative positions between the hitch mount 12 and the hitch latch 22 (e.g., relative to the first and second axis A, B) or connection of supporting chains and electrical connections between the hitch mount 12 and the hitch latch 22. In some embodiments, the position and/or orientation of trailer 20 may be compared against previously determined positions and/or orientations of trailer 20. As such, controller 130 may identify large, repeated, cyclical, erratic, or otherwise potentially hazardous movements of trailer 20. Thus, controller 130 may identify when trailer 20 is experiencing instability (e.g., based on frequency and/or amplitude of movements) and/or hazardous movements. Such a condition may be indicative of a hazardous condition. For example, an improperly balanced load may be causing excessive trailer sway. Accordingly, controller 130 may detect the presence of a potentially hazardous condition with respect to trailer 20 by comparing the position and/or orientation of trailer 20 against a previously determined positions and/or orientations of trailer 20. In some embodiments, the instructions may include predictive and/or expected angle thresholds between the first axis A and the second axis B based on inputs to the steering system 24. For example, a degree that the steering wheel is turned may be directly proportional to the predictive and/or expected angle thresholds and the actual angle between the first axis A and the second axis B can be compared to the predictive and/or expected angle threshold. If the actual angle between the first axis A and the second axis B is outside of the predictive and/or expected angle threshold, the control system 200 may generate a signal to the notification device 140.

The steering translation module 214, may include instructions to adjust the predictive and/or expected angle threshold. As such, a degree that the vehicle 10 is being turned may be detected and the predictive and/or expected angle threshold can be increased or decreased proportionally. In this manner, the control system 200 may be in communication with the steering system 24 and notification device 140 via a communication module 216 that may communicate via wireless and/or wired technology.

In some embodiments, the presence identification of trailer 20 and/or load 30, or lack thereof, may be compared against previous object identification analyses. As such, controller 130 may identify when trailer 20 is hooked up to vehicle 10 and/or when load 30 is added to or removed from trailer 20. Thus, the removal of trailer 20 and/or load 30 may be identified. Such a condition may be indicative of a potential theft. Accordingly, controller 130 may detect the potential theft of trailer 20 and/or load 30 based, at least in part, on comparing object identification analysis results against previous object identification analysis results. If a potential theft is identified, the memory 131 may store images from the imager 120 (e.g., of the structured light, ambient light, or flood light) until they can be examined and deleted by a user. In some embodiments, if a potential theft is identified, the memory 131 may cause the imager 120 to capture images of the trailer 20 and/or load 30 with ambient lighting and/or flood illumination (e.g., if ambient lighting is low).

Notification device 140 may be any device configured to provide an individual with a visual and/or audible alert. Accordingly, notification device 140 may be a speaker, a light, and/or a display. Further, the visual and/or audible alert may be emitted based, at least in part, on the controller's 130 detection of a presence of a potentially hazardous condition or potential theft with respect to trailer 20 and/or load 30. The individual may be a driver of the vehicle 10, an occupant of the vehicle 10, and/or an individual remotely located relative vehicle 10. In some embodiments, notification device 140 may be a part of the interior rearview assembly 140A of vehicle 10 (FIG. 3). As such, the rearview assembly 140A may display an icon, display a text notification, illuminate a light, and/or emit and audible notification based, at least in part, on the controller's detection of a presence of a potentially hazardous condition or a potential theft with respect to trailer 20 and/or load 30. In some embodiments, notification device 140 (e.g., in addition or alternatively to the rearview assembly 140A) may be a personal communications device 140B, such as a phone. In some embodiments, notification device 140 may be a computer (e.g., the computing center 140C), tablet, heads-up display, audio system of the vehicle 10, combinations thereof, and/or the like.

In some embodiments, vehicle 10 may be an at least partially autonomously driven vehicle. For example, vehicle 10 may be configured to pull over based, at least in part, on the detection of the presence of the potentially hazardous condition related to towing the trailer. Additionally, in such a condition, instead of or in addition to providing the alert to a driver of vehicle 10, the alert may be provided to an occupant of the vehicle, such as a passenger, and/or provided to an individual remotely located relative to the vehicle.

Embodiments of the present disclosure may have various advantages. For example, trailer monitoring system 100 may identify hazardous conditions related to towing a trailer and, in turn, notify the driver such that the driver may take measures to mitigate the hazard. As such, many of the problems associated with towing a trailer are substantially reduced and/or eliminated by trailer monitoring system 100.

The disclosure herein is further summarized in the following paragraphs and is further characterized by combinations of any and all of the various aspects described therein.

According to one aspect of the present disclosure, a system includes an illumination source associated with a vehicle. The illumination source is configured to emit a structured light pattern onto a portion of at least one of a trailer towed by the vehicle and, if present, a load hauled by the trailer. A camera is associated with the vehicle and configured to capture the structured light pattern and generate one or more images of a scene including the structured light pattern illuminated onto the portion. A controller is communicatively connected to the camera. The controller is configured to receive the one or more images from the camera, and create one or more depth map of the scene based, at least in part, on the one or more images. The controller is further configured to determine at least one of a position and an orientation of at least one of the trailer and the load, and detect the presence of a potentially hazardous condition related to towing the trailer.

According to another aspect, the structured light pattern includes a quasi-random arrangement of illumination elements.

According to yet another aspect, the structured light pattern is emitted onto the portion of the trailer.

According to still yet another aspect, the structured light pattern is emitted onto the portion of the load.

According to another aspect, at least one of the position and the orientation of the trailer are determined.

According to yet another aspect, a detection of a presence of a potentially hazardous condition is based, at least in part, on comparing the at least one of a position and orientation of a trailer against a previously determined position or orientation, respectively.

According to still yet another aspect, a detection of a presence of a potentially hazardous condition is based, at least in part, on a comparison indicating that a trailer underwent movement that was at least one of large, repeated, cyclical, or erratic.

According to another aspect, a detection of the presence of a potentially hazardous condition is based, at least in part, on comparing at least one of a position and orientation of a trailer against at least one of an expected position and orientation of the trailer.

According to yet another aspect, at least one of the expected position and orientation of the trailer is based, at least in part, on steering of the vehicle.

According to still yet another aspect, at least one of the position and the orientation of the load are determined.

According to another aspect, the at least one of the position and the orientation of the load are determined relative to the trailer.

According to yet another aspect, a detection of a presence of a potentially hazardous condition is based, at least in part, on comparing at least one of a position and orientation of a load relative to a trailer against previously determined positions and/or orientations of the load relative to the trailer.

According to still yet another aspect, a detection of the presence of the potentially hazardous condition is based, at least in part, on movement of the load relative to the trailer.

According to another aspect, a detection of the presence of the potentially hazardous condition is based, at least in part, on disappearance of the load from the one or more images.

According to yet another aspect, a notification device communicatively connected to a controller. The notification device is configured to provide at least one of a visual and audible alert based, at least in part, on the detection of a potentially hazardous condition.

According to still yet another aspect, the notification is provided to an occupant of the vehicle.

According to another aspect, the notification is provided to an individual remotely located relative to the vehicle.

According to yet another aspect, the vehicle is at least partially autonomously driven and configured to pull over based, at least in part, on the detection of the presence of the potentially hazardous condition.

According to another aspect of the present disclosure, a system includes a camera associated with a vehicle. The camera is configured to capture light and generate one or more images of at least one of a trailer towed by the vehicle and a load hauled by the trailer. A controller is communicatively connected to the camera and configured to receive the one or more images from the camera, perform an object identification analysis based, at least in part, on the one or more images, to identify the presence or absence of at least one of the trailer and the load, and compare the object identification analysis results against previous object identification analysis results. A potential theft of at least one of the trailer and the load is detected based, at least in part, on the comparison. A notification device is communicatively connected to the controller, the notification device configured to provide at least one of a visual and audible alert based, at least in part, on the detection of the potential theft of at least one of the trailer and the load.

According to another aspect, the notification device is configured as at least one of a mobile phone or a rearview mirror assembly.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; B and C in combination; or A, B, and C in combination.

For purposes of this disclosure, the term “associated” generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

What is claimed is:

1. A system, comprising:
an illumination source associated with a vehicle, the illumination source configured to emit a structured light pattern onto a portion of at least one of a trailer towed by the vehicle and, if present, a load hauled by the trailer;
a camera associated with the vehicle, the camera configured to capture the structured light pattern and generate one or more images of a scene including the structured light pattern illuminated onto the portion; and
a controller communicatively connected to the camera and configured to:
receive the one or more images from the camera;
create one or more depth map of the scene based, at least in part, on the one or more images;
determine at least one of a position and an orientation of at least one of the trailer and the load; and
detect a presence of a potentially hazardous condition related to towing the trailer.

2. The system of claim 1, wherein the structured light pattern includes a quasi-random arrangement of illumination elements.

3. The system of claim 1, wherein the structured light pattern is emitted onto the portion of the trailer.

4. The system of claim 1, wherein the structured light pattern is emitted onto the portion of the load.

5. The system of claim 1, wherein at least one of the position and the orientation of the trailer are determined.

6. The system of claim 5, wherein the detection of the presence of the potentially hazardous condition is based, at least in part, on comparing the at least one of the position and the orientation of the trailer against a previously determined position or orientation, respectively.

7. The system of claim 6, wherein the detection of the presence of the potentially hazardous condition is based, at least in part, on a comparison indicating that the trailer underwent movement that was at least one of large, repeated, cyclical, or erratic.

8. The system of claim 5, wherein the detection of the presence of the potentially hazardous condition is based, at least in part, on comparing the at least one of the position and the orientation of the trailer against at least one of an expected position and orientation of the trailer.

9. The system of claim 8, wherein the at least one of the expected position and orientation of the trailer is based, at least in part, on steering of the vehicle.

10. The system of claim 1, wherein at least one of the position and the orientation of the load are determined.

11. The system of claim 10, wherein the at least one of the position and the orientation of the load are determined relative to the trailer.

12. The system of claim 11, wherein the detection of the presence of the potentially hazardous condition is based, at least in part, on comparing the at least one of the position and the orientation of the load relative to at least one of the trailer against previously determined positions and orientations of the load relative to the trailer.

13. The system of claim 12, wherein the detection of the presence of the potentially hazardous condition is based, at least in part, on movement of the load relative to the trailer.

14. The system of claim 11, wherein the detection of the presence of the potentially hazardous condition is based, at least in part, on disappearance of the load from the one or more images.

15. The system of claim 1, further comprising a notification device communicatively connected to the controller, the notification device configured to provide at least one of a visual and audible alert based, at least in part, on the detection of the potentially hazardous condition.

16. The system of claim 15, wherein the alert is provided to an occupant of the vehicle.

17. The system of claim 15, wherein the alert is provided to an individual remotely located relative to the vehicle.

18. The system of claim 1, wherein the vehicle is at least partially autonomously driven and configured to pull over based, at least in part, on the detection of the presence of the potentially hazardous condition.

19. A system, comprising:
a camera associated with a vehicle, the camera configured to capture light and generate one or more images of at least one of a trailer towed by the vehicle and, if present, a load hauled by the trailer; and
a controller communicatively connected to the camera and configured to:
receive the one or more images from the camera;
perform an object identification analysis based, at least in part, on the one or more images, to identify a presence or absence of at least one of the trailer and the load;
compare the object identification analysis results against previous object identification analysis results;
detect a potential theft of at least one of the trailer and the load based, at least in part, on the comparison; and
a notification device communicatively connected to the controller, the notification device configured to provide at least one of a visual and audible alert based, at least in part, on the detection of the potential theft of at least one of the trailer and the load.

20. The system of claim 19, wherein the notification device is configured as at least one of a mobile phone or a rearview mirror assembly.
